(19) United States
(12) Patent Application Publication
(10) Pub. No.: US 2018/0147953 A1
(43) Pub. Date: May 31, 2018

(54) BATTERY WATER COOLING SYSTEM

(71) Applicants: HYUNDAI MOTOR COMPANY, Seoul (KR); KIA MOTORS CORPORATION, Seoul (KR)

(72) Inventors: Gun Goo LEE, Suwon-si (KR); Min Wook KIM, Yongin-si (KR)

(73) Assignees: HYUNDAI MOTOR COMPANY, Seoul (KR); KIA MOTORS CORPORATION, Seoul (KR)

(21) Appl. No.: 15/608,226

(22) Filed: May 30, 2017

(30) Foreign Application Priority Data
Nov. 30, 2016 (KR) 10-2016-0161326

(51) Int. Cl. B60L 11/18; B60H 1/00; H01M 10/647; H01M 10/625; H01M 10/613; H01M 10/6567; B60L 3/00

(52) U.S. Cl. CPC B60L 11/1874; B60H 1/00278; H01M 10/647; H01M 10/625; B60K 2001/005; H01M 10/6567; B60L 3/0046; B60L 2240/545; B60H 2001/00307; H01M 10/613

(57) ABSTRACT

A battery water cooling system includes: a housing to enclose an outside of a plate-shaped battery cell; a cell cover to enclose an outside of the housing and one side of the battery cell; and a cooling channel to surface-contact the cell cover on the side that encloses the outside of the housing and is provided with a hollow through which cooling water flows. In particular, the cell cover is provided on the one side of the battery cell and coupled to the same side of the battery cell while maintaining a surface-contact with the side of the battery.

### CROSS-REFERENCE TO RELATED APPLICATIONS

The present application claims priority to and the benefit of Korean Patent Application No. 10-2016-0161326, filed on Nov. 30, 2016, the entire contents of which is incorporated herein by reference.

### FIELD

The present disclosure relates to a system for cooling a battery of a vehicle using cooling water, and more particularly, to a battery cell capable of being commonly applied to various car models and a structure capable of performing heat exchange between the battery cell and a cooling channel.

### BACKGROUND

The statements in this section merely provide background information related to the present disclosure and may not constitute prior art.

Eco-friendly vehicles such as an electric vehicle and a hybrid vehicle are equipped with a motor as a driving source of the vehicles, and are equipped with an electric battery to supply electricity to the motor. In a conventional vehicle having a combustion engine, when a capacity of a fuel tank is increased, a drivable distance is increased. Similarly, the driving distance of an eco-friendly vehicle having a battery as a main power source is proportional to a capacity of a battery, and therefore the capacity of the equipped battery tends to be increased.

However, as the capacity of the battery is increased, a heat generation of the battery is increased. Therefore, if the heat is not efficiently emitted, the performance of the battery deteriorates drastically. As a result, it is desired to appropriately maintain an operating temperature of the battery.

The existing air cooling system forms an air flow path between battery cells to move air, thereby cooling the battery cells. However, there is a limit in forming the air flow paths between cells (i.e., difficulties to secure space to form air flow paths) because the space for the air flow paths is limited to a certain range while the number of battery cells increases to expand the capacity of the battery, thereby the efficiency of cooling is also limited.

In addition, the conventional vehicle has an engine of which a displacement varies according to a size and a purpose of the vehicle and therefore the capacity of the fuel tank varies accordingly. Similarly, the eco-friendly vehicle is equipped with a battery having different capacity according to a car model.

However, if the battery is separately designed to be fitted in each vehicle, the cost of the battery cell is increased and a problem arises even when design specifications of the battery needs to be changed according to the design change of the vehicle. Further, even if a problem arises in only some of the battery cells of the battery, there is a problem that the entire battery has to be replaced and repaired.

The matters described as the related art have been provided only for assisting in the understanding for the background of the present disclosure and should not be considered as corresponding to the related art known to those skilled in the art.

### SUMMARY

The present disclosure provides a battery water cooling system capable of effectively cooling each battery integrated in a narrow space, in the batteries stacked on the basis of one battery cell as a basic unit.

In one form of the present disclosure, a battery water cooling system includes: a housing configured to enclose an outside of a plate-shaped battery cell; a cell cover configured to enclose an outside of the housing and one side of the battery cell, the cell cover disposed on and configured to surface-contact to the one side of the battery cell; and a cooling channel configured to surface-contact the cell cover on the side that encloses the outside of the housing and is provided with a hollow through which cooling water flows.

The battery cell may be expanded by heat generated during an operation of the battery cell and push the housing according to the expansion of the battery cell and the housing may push the cell cover and increase adhesion between the cell cover and the cooling channel.

The housing may be inserted into one side surface and another side surface of the battery cell to be coupled thereto so as to enclose the outside of the battery cell.

The battery water cooling system may further include: a thermal interface material configured to be coupled to the another side surface of the battery cell while one surface of the thermal interface material is surface-attached to the another side surface of the battery cell.

The thermal interface material may be provided between the cell cover and the cooling channel.

The housing, the cell cover, and the thermal interface material may be provided in plural and may be stacked in such a manner that the cell cover surface-attaches to another surface of the thermal interface material, and the cooling channel may be coupled to the cell cover while extending in a direction in which the cell cover is stacked.

The cell cover may include: a central part configured to enclose one side of the battery cell; and an extension configured to extend from both ends of a central part and enclose one outside and another outside of the housing, the another outside facing the one outside of the housing.

An end of the extension may be provided with a locking ring and the locking ring may lock the housing at another surface of the battery cell to fix the housing and to couple the cell cover and the housing.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of a battery water cooling system;

FIG. 2 is a diagram illustrating a housing of the battery water cooling system;

FIG. 3 is a diagram illustrating a cell cover of the battery water cooling system; and

FIG. 4 is a cross-sectional view taken along the line A-A of FIG. 1.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

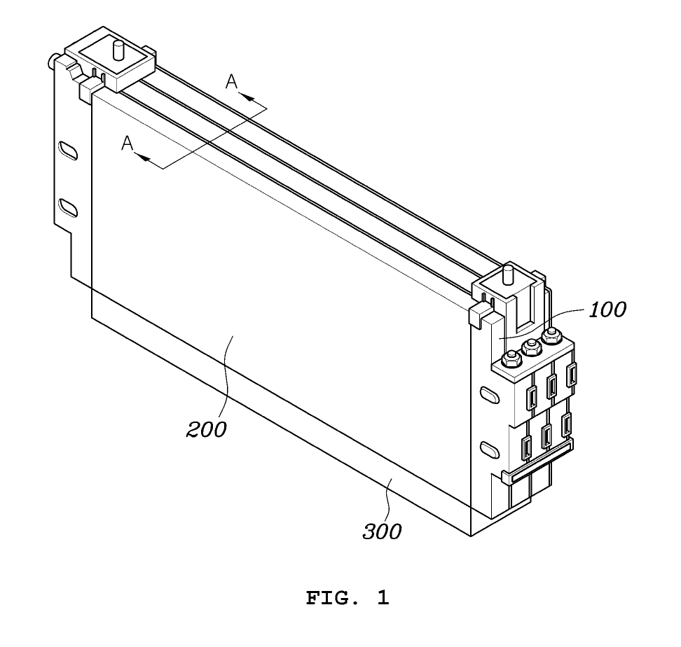

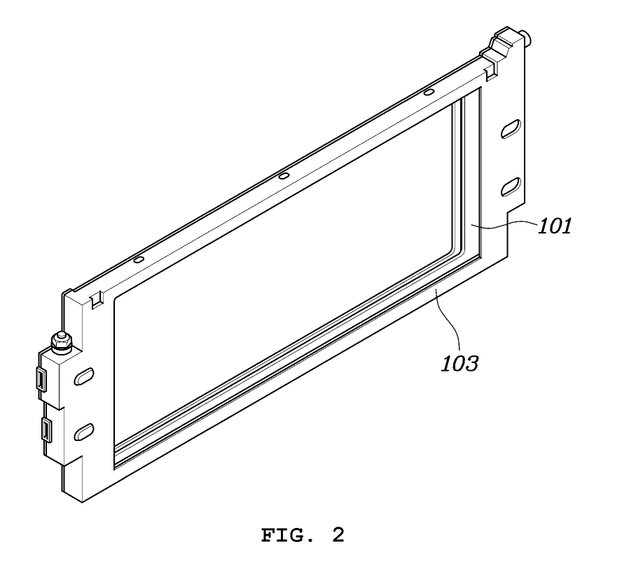

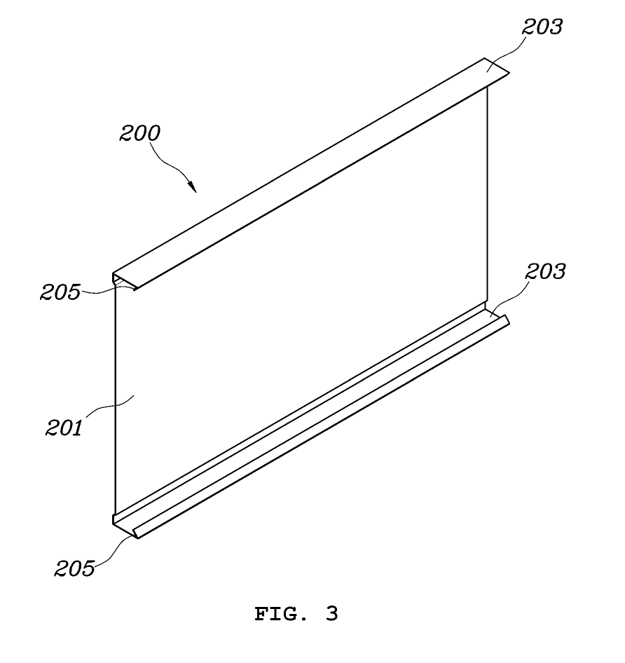

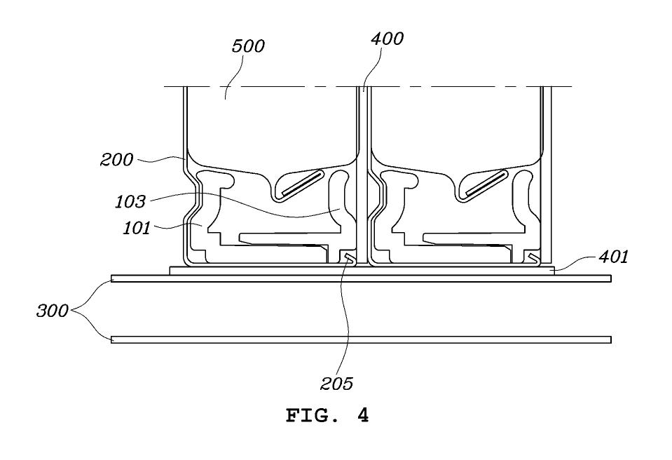

FIG. 1 is a perspective view of a battery water cooling system in one exemplary form of the present disclosure, FIG. 2 is a diagram illustrating a housing of the battery water cooling system in one form of the present disclosure, FIG. 3 is a diagram illustrating a cell cover 200 of the battery water cooling system, and FIG. 4 is a cross-sectional view taken along the line A-A of FIG. 1.

The battery water cooling system includes: a housing 100 configured to enclose an outside of a plate-shaped battery cell 500; a cell cover 200 configured to enclose an outside of the housing 100 and one side of the battery cell 500; and a cooling channel 300 configured to surface-contact the cell cover 200 on a side that encloses the outside of the housing 100 and is provided with a hollow through which cooling water flows. In particular, the cell cover 200 is disposed on one side of the battery cell 500 and coupled to the one side of the battery cell 500 in a surface-contact form.

The battery cell 500 may be expanded by heat generated during an operation of the battery cell 500 and may push the housing 100 according to the expansion of the battery cell 500. The housing 100 may also push the cell cover 200 such that the degree of adhesion between the cell cover 200 and the cooling channel 300 increases. The battery water cooling system may further include a thermal interface material 400 having one surface thereof coupled to the other side of the battery cell 500 so that the one surface of the thermal interface material 400 is surface-attached to the other side of the battery cell 500.

As illustrated in FIGS. 1 to 3, one unit battery cell 500 constituting the battery is configured to include the housing 100 enclosing the battery cell 500, the cell cover 200 coupled to the housing while enclosing the housing 100, and the thermal interface material 400 coupled to the other side of the battery cell 500 while being surface-attached thereto.

In addition, the cooling channel 300 is coupled to the cell cover 200 on the side enclosing the outside of the housing 100 while surface-contacting the cell cover 200. Although the contact part between the cooling channel 300 and the cell cover 200 is only a part of the cell cover 200, the cell cover 200 is made of a metal material having excellent heat conductivity and is coupled to one side of the battery cell 500 while surface-contacting one side of the battery cell 500, and therefore is configured to effectively transfer the heat of the battery cell 500 to the cooling channel 300. As a material of the cell cover 200, aluminum, or the like may be used.

Even when the battery cell 500 is expanded by heat during the operation, the cell cover 200 is pushed to the cooling channel 300 via the housing 100, and thus the cell cover 200 better adheres to the cooling channel 300, such that heat radiation property is improved.

A thermal interface material 401 may be provided between the cell cover 200 and the cooling channel 300.

The thermal interface material (TIM) 401 is provided between the cooling channel 300 and the cell cover 200 to remove an air insulating layer that may be formed between the cooling channel 300 and the cell cover 200, such that the heat conduction efficiency may be increased.

The housing 100, the cell cover 200, and the thermal interface material 400 are provided in plural and are stacked in such a manner that the cell cover 200 surface-attaches to the other surface of the thermal interface material 400, and the cooling channel 300 may be coupled to the cell cover 200 while extending in a direction in which the cell cover 200 is stacked.

As described above, the housing 100, the cell cover 200, and the thermal interface material 400 configure the unit battery cell 500. By adjusting the number of unit battery cells 500 and coupling therebetween, even if the desired battery capacity is different according to a car model, it is possible to easily change and adjust the capacity of the battery.

The stacked scheme is as follows. Referring to FIGS. 1 to 4, the cell cover 200 is stacked in such a manner that the cell cover 200 of another unit battery cell 500 is coupled to the other surface of the heat interface material 400 while the cell cover 200 surface-contacts the other surface of the heat interface material 400 in the state in which one surface of the thermal interface material 400 surface-contacts the other surface of the battery cell 500. As a result, since the air flow path need not be formed between the battery cells 500, the integration of the battery cells 500 is increased and thus the space occupied by the battery cells 500 is reduced.

Although the flow space of the air may be disappeared, the heat generated during the operation of the battery may be sufficiently emitted because the heat radiation is performed by utilizing the cooling water whose heat capacity is much higher than air.

The housing 100 may be inserted into one side surface 101 and the other side surface 103 of the battery cell 500 to be coupled thereto, thereby enclosing the outside of the battery cell 500.

As illustrated in FIGS. 2 and 4, the housing 100, which is a basic component configuring the unit battery cell 500, consists of two parts and is configured to be assembled at both sides of the battery cell 500, such that the housing 100 has excellent assembling performance with the battery cell 500.

The cell cover 200 includes a central part 201 configured to enclose one side of the battery cell 500; and an extension 203 configured to extend from both ends of a central part 201 and enclose one outside and the other outside facing the one outside among the outsides of the housing 100. An end of the extension 203 is provided with a locking ring 205, and the locking ring 205 fixes the housing 100 at the other surface of the battery cell 500 so as to couple the cell cover 200 and the housing 100.

As illustrated in FIG. 4, the housing 100 is locked at the other surface of the battery cell 500 by the locking ring 205 of the cell cover 200 to inhibit or prevent the housing 100 consisting of two parts from being separated, such that the cell cover 200 may better adhere to the battery cell even if the battery cell 500 is inflated during the operation.

As described above, even when the battery cells are stacked in the narrow space, the cooling may be effectively performed by the cooling water having the high heat transfer capacity. Furthermore, even when the volume of the battery is changed as the temperature of the battery is increased, the contact performance with the cooling channel may be improved and thus the cooling efficiency may be increased.

Although the present disclosure has been shown and described with respect to specific exemplary forms, it will be obvious to those skilled in the art that the present disclosure may be variously modified and altered without departing from the spirit and scope of the present disclosure.

What is claimed is:

1. A battery water cooling system, comprising:
a housing configured to enclose an outside of a plate-shaped battery cell;
a cell cover configured to enclose an outside of the housing and one side of the battery cell, the cell cover disposed on and configured to surface-contact to the one side of the battery cell; and
a cooling channel configured to surface-contact the cell cover on a side that encloses the outside of the housing and is provided with a hollow through which cooling water flows.

2. The battery water cooling system of claim 1, wherein the battery cell is configured to be expanded by heat generated during an operation of the battery cell and push the housing according to the expansion of the battery cell, and the housing is configured to push the cell cover and increase adhesion between the cell cover and the cooling channel.

3. The battery water cooling system of claim 1, wherein the housing is inserted into one side surface and another side surface of the battery cell to be coupled thereto so as to enclose the outside of the battery cell.

4. The battery water cooling system of claim 1, further comprising:
a thermal interface material configured to be coupled to the another side surface of the battery cell while one surface of the thermal interface material is surface-attached to the another side surface of the battery cell.

5. The battery water cooling system of claim 4, wherein the housing, the cell cover, and the thermal interface material are provided in plural and are stacked in a form that the cell cover surface-attaches to another surface of the thermal interface material, and the cooling channel is coupled to the cell cover while extending in a direction in which the cell cover is stacked.

6. The battery water cooling system of claim 1, wherein the thermal interface material is provided between the cell cover and the cooling channel.

7. The battery water cooling system of claim 1, wherein the cell cover includes:
a central part configured to enclose one side of the battery cell; and
an extension configured to extend from both ends of the central part and enclose one outside and another outside of the housing, the another outside facing the one outside of the housing.

8. The battery water cooling system of claim 7, wherein an end of the extension is provided with a locking ring and the locking ring is configured to lock the housing at another surface of the battery cell to fix the housing and to couple the cell cover and the housing.
